(19) United States
(12) Patent Application Publication
(10) Pub. No.: US 2013/0017703 A1
(43) Pub. Date: Jan. 17, 2013

(54) Releasable Connector System

(71) Applicants: Jeffrey N. Gamelsky, Palo Alto, CA (US); Pierre-Andre Mugnier, Sherwood (CA)

(72) Inventors: Jeffrey N. Gamelsky, Palo Alto, CA (US); Pierre-Andre Mugnier, Sherwood (CA)

(73) Assignee: Jeffrey N. Gamelsky, Palo Alto, CA (US)

(21) Appl. No.: 13/548,056

(22) Filed: Jul. 12, 2012

Related U.S. Application Data
(60) Provisional application No. 61/507,947, filed on Jul. 14, 2011.

(51) Int. Cl. H01R 13/625

(52) U.S. Cl. 439/345

(57) ABSTRACT

The preferred embodiments described herein provide a releasable connector system. In one preferred embodiment, a connector plug contains a conical element with a recessed groove. A jack contains features that allow mating with the conical shaped plug. Electrical contacts are embedded within the plug. The jack portion contains spring loaded contacts that are self-centered by the conical shape. The conical shape eases the ability to mate the plug and jack compared to a standard plug with a cylindrical jack. With this preferred embodiment, contact is made in any axial rotation. A lateral force to the jack or cord will dislodge the jack, reducing the likelihood of tripping over a cord, causing a fall, or damaging equipment.

### CROSS REFERENCE TO RELATED APPLICATIONS

This application is the Utility Patent filing for Provisional Application No. 61/507,947 filed Jul. 14 2011, Entitled “Releasable Connector System”.

### FIELD OF THE DISCLOSURE

The subject matter of this disclosure relates to a releasable connector for use in any electronic device including but not limited to laptop computers, power adapters and power tools.

### Prior Art

U.S. Patent Documents

| | | |
|---|---|---|
| 7,517,222 | April 2009 | Apple Computer |
| 7,351,066 | April 2008 | Apple Computer |
| 7,500,882 | March 2009 | RePlug |

### Other References

### BACKGROUND

Portable electronic devices (laptops, notebooks, etc.) often have a DC power plug connector that is used to power the device and to charge the battery. These plugs are usually pushed into a recessed jack which mate connections and allow power to flow to the device. These plugs are cylindrical in shape and can only be removed when pulled out directly in-line with the cylindrical axis. The connector is not designed to be removed when a lateral force is applied. These connectors are not designed to sustain a non-axial force and may break or damage a built-in board mounted connector on an electronic device. A cord is attached to the connector which in turn connects to a power adapter or directly to a wall plug. In the event a user accidentally trips over the cord the connector can be broken or worse the individual and/or computer can be damaged from a fall. What is then required is a connection that will allow safe release of a DC power connector without damage to the device and alleviate a trip hazard for users.

### SUMMARY OF THE INVENTION

The described releasable connector alleviates the safety and convenience concerns with current power connectors. An additional benefit is that the portable device built-in connector is protected. The built-in connector longevity is increased by less frequent insertion and removal of a standard plug. Forces to the integrated connector are reduced, thus protecting the device from damage and repair costs. Insertion of the releasable connector is made easier by the self-centering conical/or tapered shape. Mating of the jack body to the plug can be made in any axial rotation angle thus ensuring ease of use. In an alternative embodiment the conical shaped element is integrated into a connector that is mounted to a circuit board for OEM applications.

### DETAILED DESCRIPTION

By way of introduction, the preferred embodiments described below provide a releasable connector system. In one preferred embodiment, a conically shaped plug is inserted into a laptop jack. A pronged jack is then snapped onto the conically shaped plug which makes electrical contact with the plug. A standard laptop power plug and cord is inserted into the pronged jack allowing the laptop to power on or charge.

The pronged jack portion contains features that snap into a groove on the conical portion of the plug. A mating pair is established by the diameter of the groove and mating feature on the pronged jack.

The pronged elements hold the two connector parts together and are stable enough to support the weight of the power cable. The design of the pronged elements allows a non-axial force to disconnect the plug and jack without causing damage to the device connector. The design geometry allows the pronged elements to release without snagging on the plug element. The connector may also be disconnected when an axial force is applied to the connector.

Changing the diameter of the groove and corresponding pronged jack feature allow differing sizes to be established which will only mate with a corresponding mating part. This is beneficial as some power adapters supply different voltage and current and prevents the wrong adapter from being used.

A light source can be added to either or both sections of the releasable connection system allowing visible confirmation of a charging state. The light source is preferably an LED indicator. An illuminated ring may be included on the plug and/or jack element for higher visibility.

In the preferred embodiment the plug and jack portions of the releasable connector system are axially aligned. In an alternative embodiment the jack portion of the releasable connector system may be normal (90 degrees) to the plug element. This allows the depth of the releasable connector system to be reduced. Additionally, the angle can be different than 90 degrees or any angle from 0-90 degrees.

An alternative embodiment consists of an integral adjustment feature which allows the user to change the angle to their preference.

This invention is not limited to power connectors. Signal connectors such as USB, serial devices, audio plugs and other types of connectors would benefit from this releasable connector system.

The design of the releasable connector system features high current spring loaded pins which allow current of up to 9 Amps continuous current. The use of these high current power rated pins allows the releasable connector system to be used with standard 140 Watt and greater power adapters.

An alternative embodiment mates the releasable connection system to a power adapter. In this embodiment the plug portion of the design is hard wired to the power adapter creating a complete charging solution for various devices. In this embodiment a multitude of different sized plugs can be included to mate with various sized jacks from different manufacturers.

In another embodiment the conical shaped portion of the jack or plug is integrated into the built-in laptop connector which is soldered to the computer motherboard. In this embodiment the user only has to plug in one part. In this embodiment an OEM power adapter cable is hard wired to the pronged jack.

In the above embodiments the pin connection surface is described in a concentric arrangement, but the connection arrangement can be in-line.

The preferred embodiments will now be described with reference to the attached drawings.

### BRIEF DESCRIPTION OF THE DRAWINGS

FIG. 1 is an illustration of a power connector according to prior art.

FIG. 2 is an illustration of a releasable connector system of a preferred embodiment.

FIG. 3 is an illustration of a releasable connector system of a preferred embodiment showing the two basic elements separated.

FIG. 4. is an illustration of a preferred embodiment of a releasable connector system installed in an electronic device.

FIG. 5 is a sectional view of releasable connector system of a preferred embodiment.

FIG. 6 is an exploded view illustration of the releasable connector system and standard plug

FIG. 7 is an illustration of an alternative embodiment of the pronged elements

FIG. 8 is an illustration of an alternative embodiment of the jack body whereas the jack and plug are not axially aligned.

FIG. 9 is an illustration of an alternative embodiment where a light source is embedded into one or both elements of the releasable connector system.

FIG. 10 is an illustration an illuminated light ring indicator.

FIG. 11 is an illustration of an alternative embodiment of the jack body

FIG. 12 is an illustration of a releasable connector system having a USB connector.

FIG. 13 is an illustration of an additional embodiment of the releasable connector system in which the retention features are integrated into a device as a connector.

FIG. 14 is an illustration of an additional embodiment of the releasable connector system in which the conical features are integrated into a device as a connector.

FIG. 15 is an illustration of the releasable connector system integrated into a power adapter

FIG. 16 is an illustration of the releasable connector system integrated into a power adapter

### DETAILED DESCRIPTION OF THE PRESENTLY PREFERRED EMBODIMENTS

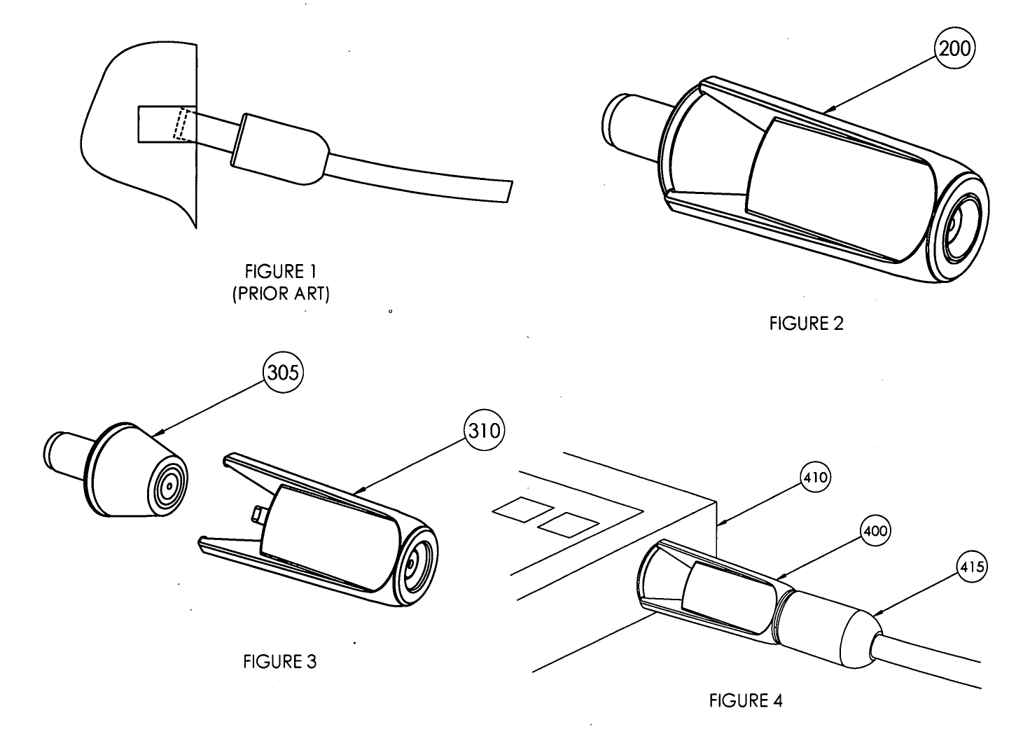

Turning now to the drawings, FIG. 1 is an illustration of a power connector 100 according to prior art. If a non-axial force is applied to the plug then the jack or device can be damaged.

FIG. 2 is an illustration of an assembled releasable connector 200 of a preferred embodiment.

FIG. 3 is an illustration showing the two main elements of a releasable connector of a preferred embodiment. The releasable connector 300 consists of two main elements:connector plug 305 and jack body 310.

FIG. 4 is an illustration showing the releasable connection system 400 installed in a laptop 410 or similar device. The standard OEM power cord 415 is shown installed in-line with the jack.

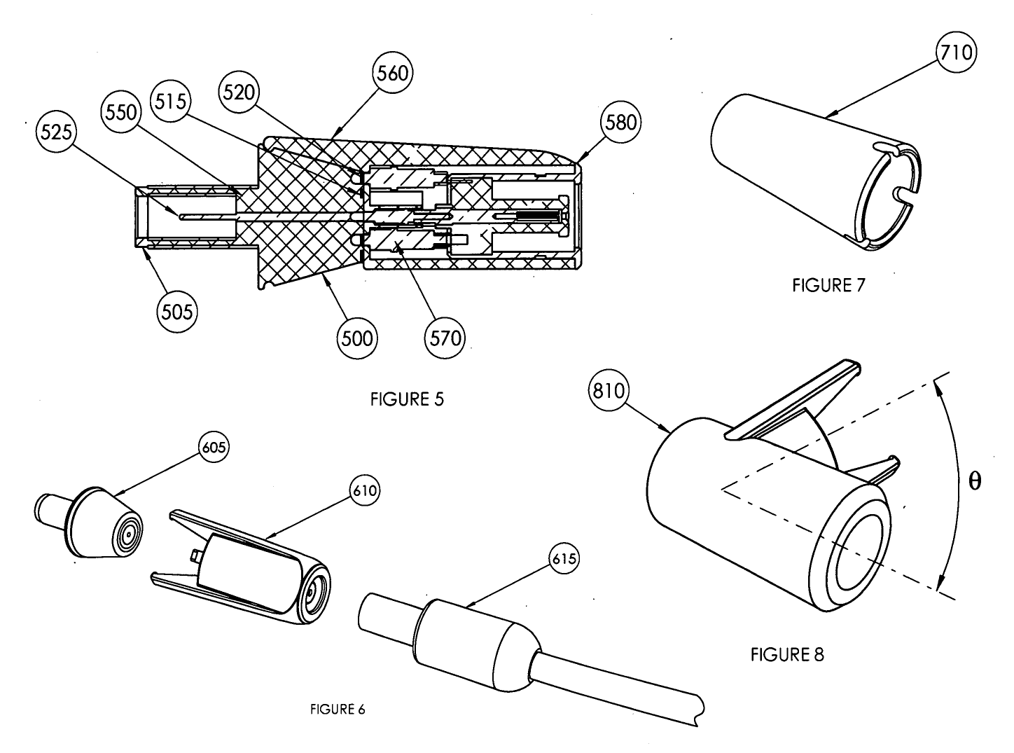

FIG. 5 is a sectional view of the releasable connector system. The releasable connector comprises a number of elements: connector plug 505, plug body 550, plug positive element 515, plug negative element 520 and plug sensing pin 525. The jack portion comprises a mating body 560, spring loaded pins 570 and jack 580. The releasable connector system may comprise of additional elements.

Additional connections can be added as needed for additional voltages or signals. The spring loaded power pins can supply 9 amps of current as needed for power adapters to charge a battery. Smaller pins can be used for signals or lower current requirements. The conical shaped plug body 550 and pronged jack body 560 is made of a thermoplastic material. The material is designed to deflect when connected but sufficiently strong to not break when disconnected.

FIG. 6 is an exploded view illustration of the releasable connector system shown with connector plug 605, jack body 110 and an OEM cable 615.

FIG. 7 is an illustration showing an alternative embodiment to the pronged jack body 710. In this configuration the three protrusions take the form of an inverted conical shape. The notches allow the ability of the material to flex and snap into the mating groove. The notches may or may not be required.

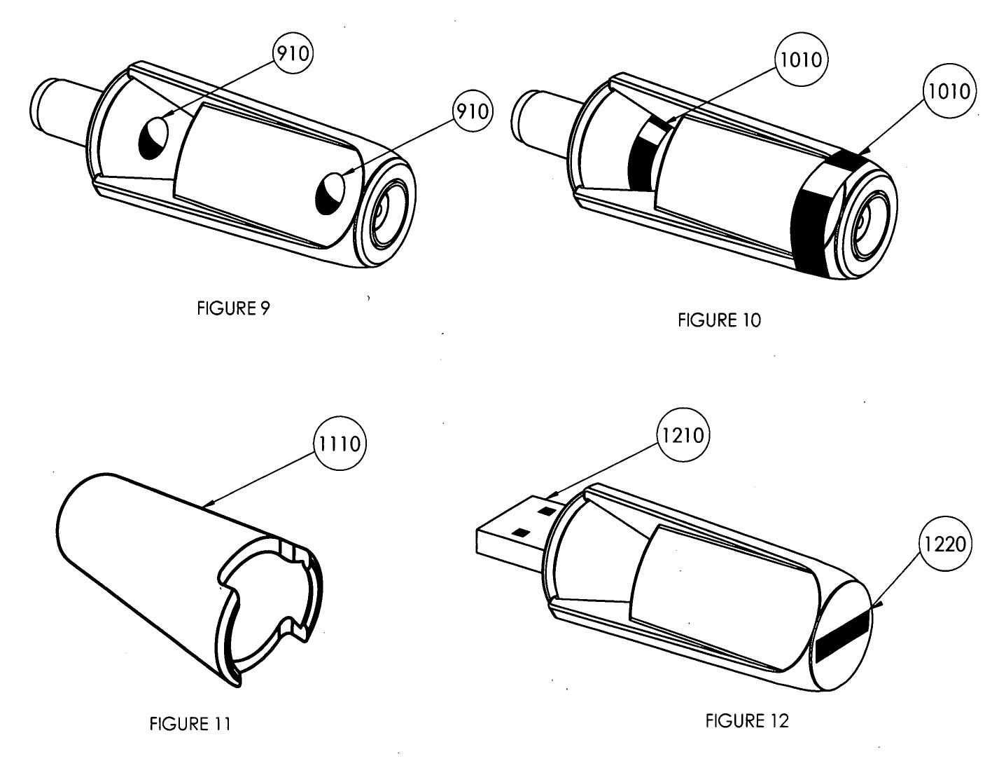

FIG. 8 is an illustration of an alternative embodiment where the pronged jack is not axially aligned with the plug. In this illustration the angle is fixed, but an alternative embodiment provides for an adjustable angle that can be set by a user.

FIG. 9 Is an illustration showing a light source indicator 910 on the jack and plug. The light source is preferably an LED.

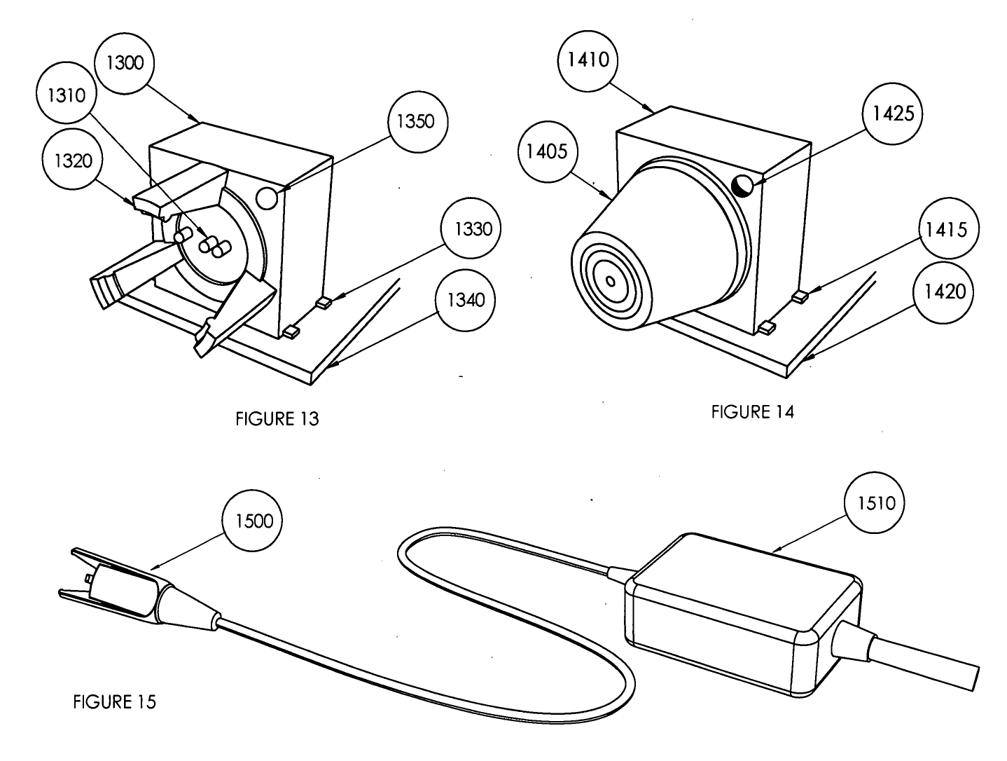

FIG. 10 Is an illustration showing an illuminated light ring indicator 1010. The light ring is a translucent or clear plastic component. The light ring is shown located on both elements of the releasable connector system.

FIG. 11 is an illustration of an alternative embodiment of the jack body 1110 where there are two pronged protrusions that mate to the conical jack body.

FIG. 12 is an illustration of a releasable connector system having a USB connector. The conical plug includes a USB male plug 1210. The jack body contains a female USB jack 1220. This example, shows one of the various forms that the releasable connector system can take using various connector types. Other types of USB connectors can be utilized such as mini USB and micro USB.

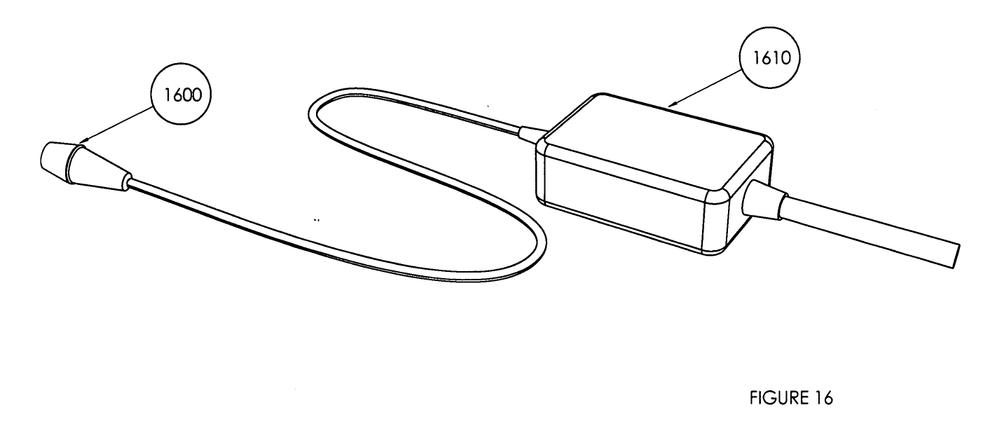

FIG. 13 is an illustration of an embodiment where the pronged element portion of the plug 1320 is integrated into a board mount connector 1300. The connector contains solder pins 1330 to attach to the device circuit board 1340. Spring loaded pins 1310 provide power to the mating releasable connector. An LED 1350 signifies power is flowing through connector. The pins may be surface mount or through hole type. This configuration may be utilized by an OEM to embed the releasable connector system into a product.

FIG. 14 is an illustration of an embodiment where the conical shaped portion of the plug 1405 is integrated into a board mount connector 1410. The connector contains solder pins 1415 to attach to the device circuit board 1420. An LED 1425 signifies power is flowing through connector. The pins may be surface mount or through hole type. This configuration may be utilized by an OEM to embed the releasable connector system into a product.

FIG. 15 is an illustration showing the releasable connector system is wired directly to a power adapter 1510. In this embodiment the pronged element 1500 of the releasable connector system is shown.

FIG. 16 is an illustration showing the releasable connector system is wired directly to a power adapter 1610. In this embodiment the conical shaped element 1600 of the releasable connector system is shown.

It is intended that the foregoing detailed description be understood as an illustration of selected forms that the invention can take but does not limit the forms of the invention. Interchangeable elements of the releasable connector system have been described but are not limited by those described. For example, the jack is shown in an axial arrangement in the preferred embodiment but having the jack be normal to the plug, with a USB connector is another possible embodiment.

What is claimed is:

1. A releasable connector system comprising: a first conical element having a first plurality of electrical contacts; and a second retention element having a second plurality of mating electrical contacts and retention elements; where mating conical surfaces contain a groove to mate with retention feature elements; where the first element contains either a plug or jack and the second element contains the mating plug or jack.

2. The invention of claim 1 wherein the mating retention features consist of protrusions that snap into the groove on the conical surface.

3. The invention of claim 1, wherein the groove is positioned in different locations along the conical surface.

4. The invention of claim 1, wherein the conical element contains electrical contacts arranged in a concentric arrangement.

5. The invention of claim 1, wherein the conical element contains electrical contacts arranged in a linear arrangement.

6. The invention of claim 1, wherein the mating jack contains spring loaded contacts arranged to mate with a concentric arrangement.

7. The invention of claim 1, wherein the conical element is an integrated part of a connector within an electronic device.

8. The invention of claim 1, wherein the retention element is an integral part of a connector within an electronic device.

9. The invention of claim 1, wherein a light source is embedded into the plug and/or jack element to signify a charging or powered state.

10. The invention of claim 1, where a light source comprising an illumination ring is disposed around the conical element.

11. The invention of claim 1, where a light source comprising an illumination ring is disposed around the jack element.

12. The invention of claim 1, where the jack portion is at a right angle to the plug element

13. The invention of claim 1, where the jack portion is not axially aligned with the plug element.

14. The invention of claim 12, where the jack portion contains a pivot so the angle of the jack to the plug can be changed.

15. The invention of claim 1 where the jack element is wired directly to a power adapter

16. The invention of claim 1 where the plug element is wired directly to a power adapter

17. The invention of claim 1 where the jack portion can disconnect from the plug portion when pulled by a non-axial force.

18. The invention of claim 1 where the jack portion can disconnect from the plug portion when pulled by an axial force.

19. The invention of claim 2, wherein the retention feature protrusion quantity is 2 or more.

20. The invention of claim 1, wherein the conical shaped element is curved.
